(19) United States
(12) Patent Application Publication
(10) Pub. No.: US 2008/0057341 A1
(43) Pub. Date: Mar. 6, 2008

(54) WIRE, FLUX AND PROCESS FOR WELDING STEEL HAVING A HIGH NICKEL CONTENT

(75) Inventors: Claude BOUILLOT, Triel S/Seine (FR); Corinne CHOVET, Conflans Ste Honorine (FR)

Correspondence Address: YOUNG & THOMPSON, 745 SOUTH 23RD STREET, 2ND FLOOR, ARLINGTON, VA, 22202, US

(73) Assignee: L'AIR LIQUIDE SOCIETE ANONYME POUR L'ETUDE ET L'EXPLOITATION DES PROCEDES GEORGE, Paris (FR)

(21) Appl. No.: 11/850,769

(22) Filed: Sep. 6, 2007

(30) Foreign Application Priority Data
Sep. 6, 2006 (FR) 06 53588

(51) Int. Cl. B32B 15/01; B23K 26/00; B23K 35/22; B23K 9/18; B23K 9/23

(52) U.S. Cl. 428/685; 219/121.85; 219/137 WM; 219/145.22; 219/73

(57) ABSTRACT

The invention relates to a flux-cored wire for welding nickel steels, comprising a steel sheath and filling elements, and containing, relative to the weight of the wire, 2 to 15% fluorine, 8 to 13% nickel, and iron; a welding flux containing, in proportions by weight, 25 to 35% MgO, 20 to 30% CaO, 10 to 15% Si02, 10 to 30% A1203 and 5 to 20% fluorine; and a welding process in particular a submerged-arc welding process using this wire and this flux to join steel workpieces containing more than 6% nickel, preferably around 9% nickel.

The invention relates to the high-productivity homogeneous welding of nickel steels, in particular 9% Ni steels.

9% nickel steels, commonly called “9% Ni steels”, are materials used for the construction of tanks or other industrial equipment intended for use at cryogenic temperatures, such as for example pipes.

For this purpose, these steels are characterized by good mechanical strength and good impact strength, even at liquid nitrogen temperature, i.e. −196° C.

9% Ni steels are steels of the low-carbon type containing about 9% nickel by weight and are subjected to an appropriate heat treatment in order to maintain good ductility at very low temperature.

This type of steel is characterized by a low carbon content, typically less than 0.1% by weight, and above all a low level of impurities, in particular sulphur and phosphorus. This is because a low level of inclusion impurities is an essential factor for ensuring good impact strength at low temperature and for limiting the risk of temper brittleness.

Faced with the growing demand for energy, liquefied natural gas offers an advantageous alternative to current oil products. For this reason and owing to their low-temperature properties, 9% Ni steels are being increasingly used for producing equipment serving for the storage and transport of non-corrosive cryogenic fluids, such as natural gas, and to do so down to temperatures of around −196° C.

However, to manufacture such equipment from 9% Ni steel, it is necessary to use special welding products and a special welding process, that is to say making it possible to achieve the same level of mechanical properties in the melted zoneMZ/and in the heat-affect zone (HAZ).

In other words, the problem that arises when welding such 9% Ni steels is therefore how to obtain good mechanical properties in the MZ and HAZ, in order to ensure integrity of the assembly for the lowest manufacturing cost.

Currently, the consumable wires for welding 9% Ni steels are of two types, namely ferritic filler products for homogeneous welding and filler product having a very high Ni content for heterogeneous welding.

Heterogeneous welding is the most commonly used. In this case, all arc welding processes may be used, in particular submerged-arc welding. Assembly of 9% Ni steel parts or plates is carried out with austenitic consumable wires of the nickel-based type containing a very high nickel content, typically at least 50% nickel. The weld obtained with such consumables is austenitic and consequently does not have a ductile-brittle transition. It therefore has good toughness properties even at liquid nitrogen temperature.

However, the use of such Ni-based filler metals introduces several drawbacks, namely:
despite the high productivity of this process, the high cost of the filler metals with a high Ni content, particularly the high cost of consumable wires, makes this solution expensive and therefore not competitive from the economic standpoint;
certain filler metals of the nickel-based type have a high sensitivity to hot cracking; and
finally, and above all, the tensile strength of the melted metal is lower than that of the base metal. For example, the tensile strength of the melted zone (MZ) may drop down to 640 MPa, depending on the configuration of the joint, whereas the base metal has a tensile strength of greater than 700 MPa. This results, in the case of tanks, in the equipment being overdimensioned in order to meet the recommendations of the construction codes and, in the case of longitudinally welded pipes, this makes it impossible for the pipe to be correctly formed after welding.

In homogeneous welding, a bulk wire of chemical composition close to that of the base metal is used, in particular as regards their nickel contents.

Combined with a TIG or MIG welding process, current homogeneous ferritic consumable wires allow sufficient low-temperature toughness values to be achieved without heat treatment, i.e. 34 J at −196° C. for test specimens of standard size (10×10 mm) with a tensile strength compatible with that of the base metal.

However, the use of these consumable wires, despite their advantageous cost, is not economically viable owing to the low productivity of these processes.

Furthermore, with other processes of higher productivity, and in particular submerged-arc welding as described by the document Production of 9% Nickel Steel UOE Pipe with Ferritic Filler Submerged Arc Welding, Transactions ISU, Vol. 26, 1986, pp. 359-366, homogeneous consumables of the bulk wire type do not allow the required toughness level to be achieved.

Moreover, the use of a bulk wire is not ideal as it requires, for each adjustment in composition, for example in order to take into account the % nickel content in the base metal, a metal casting operation to be carried out in order to manufacture the wire to the desired composition. This is detrimental from the economic standpoint and causes production difficulties.

In addition, in this case, to achieve the required toughness level at −196° C., it is essential to carry out a heat treatment on the entire apparatus, something which is not often achievable owing to the geographical situation of the welded equipment, in particular on a work site, or when the equipment is of very large dimensions, namely several meters, such as for example welded pipes.

Finally, the weld obtained with this type of process using a bulk wire often has too high an oxygen content, typically greater than 0.040%.

In other words, welding consumables, namely wire, flux or a combination thereof do not exist at the present time, nor does a welding process using them that not only makes it possible to obtain good weld properties but also is economically viable and/or can be carried out on an industrial scale.

The problem is therefore how to provide a welding wire and/or a welding flux that can be used for effectively welding steels having a high nickel content particularly 9% Ni steels, and a welding process using this wire and/or this flux, resulting in good properties of the welded joint or deposited metal, which are economically viable and can be readily implemented on an industrial scale.

According to a first aspect, the invention provides a flux-cored wire for welding nickel steels, comprising a steel sheath and filling elements, characterized in that it contains, relative to the weight of the wire, 2 to 15% fluorine, 8 to 13% nickel, and iron.

The flux-cored wire of the invention is characterized by a fluorine content between 2 and 15% expressed as a proportion of fluorine (F). However, fluorine that can be used may be in various forms, in the form of fluorspar, which is preferred, but also in the form of natural or synthetic cryolite, or fluorinated compounds such as Na, Li or K fluorides, or any other fluoride.

Depending on the case, the flux-cored wire of the invention may comprise one or more of the following features:
the steel is a carbon-manganese steel, the carbon content of the sheath preferably being less than 0.05%;
the fill level of the wire with said filling elements is between 8 and 40%, preferably 12 to 30%, relative to the total weight of the wire;
the iron comes only from the steel sheath, the filling elements being free of iron, in particular free of iron powder; and
it contains, relative to the weight of the wire, 8 to 15% fluorine and 9 to 11.75% nickel.

Moreover, according to another aspect, the invention provides a process for the arc welding, laser welding or hybrid laser/arc welding of at least one workpiece made of nickel steel, preferably at least one workpiece containing at least 6% nickel, in which a flux-cored wire is employed.

Preferably, this is a submerged-arc welding process employing a flux-cored wire according to one of claims 1 to 5 and a flux containing, in proportions by weight, 25 to 35% MgO, 20 to 30% CaO, 10 to 15% SiO₂, 10 to 30% Al₂O₃ and 5 to 20% fluorine.

According to the process of the invention, one or more workpieces made of steel containing more than 7% nickel, typically 7 to 13% nickel, are welded together.

Advantageously, a welded joint is produced such that the density of passes at the welded joint is greater than 2 passes per cm².

According to yet another aspect, the invention provides a welding flux that can be used in the process according to the invention, characterized in that it contains, in proportions by weight, 25 to 35% MgO, 20 to 30% CaO, 10 to 15% SiO₂, 10 to 30% Al₂O₃ and 5 to 20% fluorine.

Preferably, said flux furthermore includes at least one constituent chosen from Na₂O and K₂O, the proportion of said at least one constituent being less than 3% by weight.

According to yet another aspect, the invention provides a welded joint or deposited metal that can be obtained by implementing a process according to the invention and/or by melting a flux-cored wire according to the invention, characterized in that it contains:
0.010 to 0.07% C, preferably 0.010 to 0.05% C;
0.02 to 0.20% Si;
0.15 to 0.6% Mn;
0.002 to 0.007% P;
0.0013 to 0.0050% S;
7 to 13% Ni;
0.002 to 0.012% Ti;
0.005 to 0.018% Al; and
predominantly Fe.
   Advantageously, the welded joint contains less than 300 ppm oxygen.

Furthermore, the welded joint may also contain barium, zirconium, chromium and/or lithium in a proportion of less than 2% by weight; it being possible for these elements to be present in metallic form, in the form of oxides and/or in the form of a compound comprising one or more of these elements.

The present invention will be more clearly understood thanks to the following explanations and examples given with reference to the appended figures.

In general, the good mechanical strength and the excellent low-temperature toughness of the base metal, that is to say of the workpieces to be welded, for example made of 9% Ni steel, are due to the improved microstructure of the material.

The microstructure of the material consists of martensite or bainite and carbon-enriched austenite. This particular structure is produced by a double normalization followed by a tempering treatment, or a quench followed by a tempering treatment. The tempering treatment is carried out in what is called the “critical temperature” range.

During this heat treatment, some austenite will appear and the carbon present in the base metal will preferentially migrate into the austenite. The carbon-rich austenite thus formed becomes stable to cooling down to −200° C.

Since the austenitic transformation is only partial, the microstructure of the steel after heat treatment will therefore consist of martensite with a very low carbon content and residual austenite. It is this particular microstructure that determines the excellent level of low-temperature toughness of the material.

The optimum residual austenite content depends on the carbon content of the steel. This is because it must be sufficient to trap the carbon of the base metal, but if it is too high, the austenite then cannot contain enough carbon to remain stable to cooling, and will be transformed to martensite. This residual austenite content is controlled by the treatment temperature, time pair.

When the tempering treatment is poorly controlled, several phenomena may take place, namely, during cooling, structure-embrittling carbides may form, and the amount of austenite formed during the treatment may be too high and not stable, thereby giving rise to the formation of fresh martensite.

Moreover, the cooling rate from the tempering temperature has a direct influence on the ductility of 9% Ni steels at low temperature.

This means that special precautions have to be taken in order to assemble 9% Ni steel parts by welding. Thus, the heat supplied by the welding process must be low and the temperature between passes must be low in order to limit transformations of the steel in the heat-affected zone (HAZ).

For welded assemblies, the heat treatment is always carried out in two phases: a quench followed by tempering at around 600° C. The austenite obtained by the tempering treatment is stable only provided that the tempering treatment is optimum.

The desired chemical composition of the deposited metal must take into account the equilibrium between mechanical strength and toughness, the alloying elements being factors that affect the toughness.

Thus, the susceptibility of the weld to temper brittleness is reduced by reducing the elements that segregate at the grain boundaries, particularly phosphorus and manganese.

In particular, the content of manganese, responsible for embrittlement, must be as low as possible in order to obtain a good level of toughness, including at −196° C. The maximum manganese content seems to be related to the carbon content, whereas the minimum manganese content is related to the sulphur content. Thus, an Mn content of 0.3% by weight is effective within the usual carbon range, i.e. around 0.05%.

Moreover, the phosphorus content must also be controlled and kept below 0.007%.

The sulphur content must be as low as possible owing to its negative impact on the risk of cracking, and its action may be counteracted by the addition of manganese. When the sulphur content is less than 0.005%, a manganese content of around 0.15% should be sufficient to obtain satisfactory results.

Nickel is the crucial element. The nickel content must be between 7 and 13% by weight, preferably more than 9% and/or less than 12%. This is because outside this range, the desired level of toughness cannot be achieved. Increasing the nickel content from 7 to 11% is reflected in a simultaneous reduction in the maximum level of energy absorption and in the ductile-brittle transition.

On the other hand, carbon does not seem to have an important effect on the level of toughness up to 0.07% by weight, the carbon content preferably being about 0.05% or less.

Silicon also plays a role and must be present with a maximum content of less than 0.2%.

To summarize, according to the invention the metal deposited on the workpiece(s) to be welded contains (by weight) phosphorus with a content of less than 0.007%, manganese with a content of preferably between 0.15% and 0.3%, carbon with a content of 0.001 to 0.070%, preferably at most about 0.050%, sulphur with a content of less than 0.005%, nickel with a content of 7 to 13%, silicon with a content of less than 0.2%, and essentially iron for the remainder.

However, it is not excluded for the welded joint also to contain titanium and aluminium

In all cases, the low level of inclusions has a tendency to increase the toughness.

In general, the nickel steel workpieces are assembled in order to form tanks, pipes or other similar structures serving in particular for the transport and storage of liquefied natural gas (LNG) at cryogenic temperatures, by any welding process capable of producing a welded assembly providing a tensile strength and an impact strength suitable for these applications.

In this regard it is possible to use the following processes: MIG/MAG welding, TIG welding, laser welding, plasma welding, hybrid laser/arc welding with filler wire or submerged-arc welding which employ a consumable wire, a welding gas, and/or a welding flux, together with a source of energy to melt the wire, which is an electric arc (or several arcs), a laser beam (or several beams) for a laser/arc combination.

Now, a welded assembly is characterized by the melted metal, the heat-affected zone (HAZ), i.e. affected by the energy source, and the base metal in the vicinity of the HAZ.

The melted metal essentially corresponds to the consumable wire that is melted and possibly to the flux deposited and diluted by the base metal melted during welding.

The HAZ is part of the base metal, that is to say of the material constituting the welded workpiece(s), which part is not melted during welding, but the microstructure and the mechanical properties of which are modified by the heat emitted during arc or laser welding.

Consequently, to construct pipes, tanks or any other equipment intended to be in contact with a cryogenic fluid, it is essential to have a welding process that allows tensile strength and toughness compatible with cryogenic applications to be obtained. Thus, the welding process must result in a ductile microstructure and mechanical properties capable of meeting the requirements of cryogenic applications, namely a minimum toughness of 34 J at −196° C. and a minimum lateral expansion of 0.38 mm, with an economically satisfactory productivity.

To obtain a satisfactory productivity and a toughness level above 34 J at liquid nitrogen temperature, the inventors of the present invention have demonstrated that the submerged-arc welding (SAW) process is the most suitable as it allows a high productivity to be achieved.

This is because the welding speed is directly proportional to the number of wires used. Thus, with one wire, the welding speed with the SAW process is generally around 50 cm/min or more, whereas with 5 wires, it is possible to achieve a speed of 250 cm/min.

Consequently, it was necessary to develop a welding wire and a flux that can be used in SAW welding according to the invention and which furthermore result in deposited metal with the composition given above.

The inventors of the present invention have therefore developed a specific flux for SAW welding making it possible to obtain the lowest possible level of oxygen and a sulphur content of the deposited metal below 0.01% by weight. The composition of this flux is given below.

In addition, as regards the consumable wire, the inventors of the present invention considered replacing the bulk wire normally used in SAW welding with a flux-cored wire in order to obtain greater flexibility of manufacture and of composition of the melted metal. The composition of this flux-cored wire is also given in detail below.

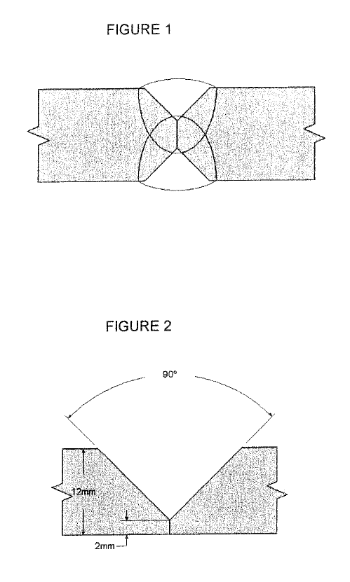

To do this, “Y” joints (FIG. 2) or “X” joints (FIG. 1) made from a 9% Ni steel with a thickness of 12 mm, of the A553 type according to the ASTM standard, were tested. To evaluate the impact of the welding energy on the level of toughness, the “Y” or “X” joint was filled with a variable number of passes using processes according to the prior art and, for comparison, using the SAW process with flux-cored wire according to the invention.

The details of these trials are given in the examples below.

### EXAMPLE 1

### SAW Welding with Bulk Wire According to the Prior Art

Thick pipes were manufactured from sheets, the two longitudinal edges of which were machined and then brought together. The shaping of the sheet allowed the machined edges to be brought together to form a pre-tube with an X-shaped profile as shown in FIG. 1.

Continuous tack welding using a MIG welding process was used to keep the assembly in position before the actual SAW welding.

Next, the welding was carried out in two passes with a submerged arc (SA) beneath a solid flux. The first pass was inside the tube, whereas the second pass was carried out on the outside of the tube so as to ensure interpenetration of the two weld beads.

We produced such an assembly from a 9% Ni steel of the A553 type according to the ASTM standard with a thickness of 12 mm. For this trial, we used a flux with a basicity index of 2.7 according to Bonisevsky. The filler product was a 9% nickel steel bulk wire with a diameter of 1.2 mm.

More precisely, the flux was a commercial flux of the CaO—MgO—Al₂O₃ type available from Oerlikon under the reference OP76, while the bulk wire used was also a commercial wire available from Kobe Steel under the reference TGS-9N.

The welding parameters are given in the following Table 1. The other operating conditions employed are those conventionally used in SAW welding produces.

TABLE 1

| | Polarity | Current | Voltage | Welding |
|---|---|---|---|---|
| | of the current | (in A) | (in V) | Speed |
| “Inside-tube” | AC | 370 | 32 | 80 cm/min |
| First pass | | | | |
| “Outside-tube” | AC | 410 | 32 | 80 cm/min |
| Second pass | | | | |

AC: alternating current.

The tubes thus welded were subjected to conventional toughness tests (of the Charpy type) which showed that, in the as-welded state, the toughness values obtained were below 34 J, despite a welding energy of 9 kJ/cm, and consequently, to obtain satisfactory values, that is to say values of at least 34 J, it was essential to carry out a post-welding heat treatment as described above, which posed the abovementioned problems.

### EXAMPLE 2

### Multi-Pass TIG Welding with Bulk Wire According to the Prior Art

A “Y” joint similar to that of Example 1 was welded by using a conventional TIG process in ten successive passes with a welding speed of 15 cm/min.

The operating conditions of the TIG welding were the conventional conditions employed for this type of process and the wire used was that of Example 1.

The level of toughness and the tensile strength of the joint thus welded were satisfactory, since they were greater than 34 J.

However, compared with the usual procedure for welding tubes in two passes, the productivity was considerably reduced and incompatible with large-scale production given that the welding speed obtained was very low owing to the large number of passes in order to fill the “Y” profile.

### EXAMPLE 3

### SAW Welding with Flux-Cored Wire According to the Invention

To check the effectiveness of the SAW welding process with flux-cored wire according to the invention, welding was carried out as in the case of Example 1, but with a “Y”-shaped profile as shown in FIG. 2.

In other words, the process carried out in Example 3 was a submerged-arc welding process carried out on 9% Ni steel product pieces with a “Y” profile (as in Example 2) employing a flux-cored wire and a powered flux.

As already mentioned, the flux used must meet a number of constraints in order to respect the level of toughness at −196° C. and to limit the risk of cold cracking. The level of toughness depends mainly on the silicon and oxygen contents.

With TIG and MIG/MAG processes, the oxygen and silicon levels may be very low and it is possible to obtain a silicon level equivalent to the filler metal, i.e. about 0.05%, and 50 ppm in the case of oxygen. However, in submerged-arc welding, the welding fluxes and the bulk wires on the market do not allow such a low oxygen level to be achieved. In general, the oxygen content is around 300 ppm for basic fluxes according to the Bonisevsky classification.

It was necessary to develop a novel welding flux with a drastic reduction in silicon and oxygen contents. Table 2 gives a flux composition meeting these criteria and used within the context of Example 3.

TABLE 2
Composition of the flux

| ZrO₂ | MgO | Na₂O | Fe₂O₃ | Cr₂O₃ | BaO | TiO₂ | MnO | CaOT | SiO₂ | K₂O | P₂O₅ | Al₂O₃ | F |
|---|---|---|---|---|---|---|---|---|---|---|---|---|---|
| 0 | 31 | 1.1 | 0.4 | 0 | 0 | 0.05 | 0.8 | 24 | 13 | 1.2 | 0.03 | 18 | 11 |

At the present time, no homogeneous flux-cored wire for welding suitable 9% Ni steel by the submerged-arc process exits. The existing consumable products are bulk wires, which pose the abovementioned problems.

Thus, to increase in particular the productivity of the welding process, the inventors of the present invention developed, and used in this Example 3, a flux-cored wire with a carbon-manganese steel sheath containing filling elements.

More particularly, the filling elements contain about 12% fluorine and 11% nickel relative to the total weight of the wire, but they contain no iron powder. This is because one of the novel aspects of the flux-cored wire of the invention is that it is free of iron powder, iron being provided by the sheath or foil.

The use of this homogeneous flux-cored wire/flux pair in an SAW welding process makes it possible to achieve the desired level of toughness at −196° C., as the results of the trials obtained show, as indicated below in Table 3, in which the results obtained in Examples 1 and 2 of the prior art and in Example 3 (Trials A, B and C) according to the invention are given.

TABLE 3
Results of comparative trials

| Trial | Example 1 | Example 2 | A | B | C |
|---|---|---|---|---|---|
| Type of | X | Y | Y | Y | Y |
| preparation | | | | | |
| (profile to be | | | | | |
| welded) | | | | | |
| Number of | 2 | 10 | 5 | 8 | 4 |
| passes | | | | | |
| Welding energy | 9 | 5 | 12 | 7 | 14 |
| (kJ/cm) | | | | | |
| Average | 8 | 200 | 38 | 34 | 48 |
| toughness | | | | | |
| at −196° C. (J) | | | | | |
| Lateral | ND | ND | 0.45 | 0.46 | 0.7 |
| expansion | | | | | |
| (mm) | | | | | |
| Welding speed | 60 | 15 | 60 | 60 | 60 |
| (cm/min) | | | | | |

ND: not determined

The results obtained show that it was necessary for there to be at least 4 passes with a Y-shaped bevel in order to obtain a sufficient level of toughness in SAW welding.

Comparing the welding energy of the trial in the X configuration with 2 welding passes (Ex. 1) with Trial C of the invention with a Y-shaped bevel and 4 passes shows that a very low welding energy is not necessarily associated with a good level of toughness. The weld obtained in Trial C resulted in a tensile strength compatible with the code for the construction of cryogenic apparatus and has an impact strength of greater than 34 J at −196° C., while still having a productivity compatible with the economic imperatives of manufacturers, something which is not the case for Example 1 although the welding process is also an SAW process.

Trial C makes it possible to obtain a low level of impurities. In addition, the desired microstructure is obtained by using an appropriate chemical composition of the melted metal and by controlling the thermal cycle.

Moreover, the conditions in Example 2 gave very good toughness values, but to the detriment of the productivity since the welding speed reached was barely 15 cm/min, whereas in the other example it was around 60 cm/min. A speed as low as that obtained in Example 2 is not acceptable from an industrial standpoint.

The limitations of the prior art processes (Ex. 1 and 2) compared with the process of the invention (Trials A to C), which makes it possible to obtain not only good toughness values but also high welding speeds compatible with use from the industrial standpoint, are immediately understood.

Apart from controlling the chemical composition of the melted zone, the welding procedure (number of passes) is an important parameter for obtaining satisfactory toughness values, both in the melted zone and in the heat-affected zone.

It can be noted that a low welding energy is desirable in order to obtain rapid cooling of the welded joint, the welding energy being defined as the welding voltage multiplied by the welding current divided by the welding speed. The welding energy within the context of the invention is preferably from 8 to 15 kJ/cm.

In view of the results given in Table 3, the inventors sought to understand why, despite a low welding energy (Ex. 1), the toughness obtained was poor, as it was less than 34 J.

As mentioned, one explanation of these results lies in the number of passes carried out.

Consequently, in order for the welding process of the invention to be better controlled, a new parameter called “density of passes”, which is the number of passes per cm², was defined.

To calculate the density of passes, a macrograph of a slice of the joint produced was used. This macrograph allows the area of the melted zone to be measured from all the passes and the number of passes carried out to be counted. The ratio of these two values (number of passes/melted area) gives the density of passes.

Table 4 below gives the density of passes and toughness values obtained for Example 1 and for the trials of Example 3.

TABLE 4
Result of the Trials

| Trial | Ex. 1 | A | B | C |
|---|---|---|---|---|
| Density of passes (nb/cm²) | 1.7 | 3 | 5 | 2.6 |
| Average toughness at −196° C. | 8 | 38 | 34 | 48 |
| (J) | | | | |

The results in Table 4 show that a density of passes greater than 2 passes per cm² is necessary in order to obtain good toughness (>34 J).

### EXAMPLE 4

### Comparative Study of the Oxygen Content of the Deposited Metal

The purpose of Example 4 was to compare the favourable impact of the use of a flux-cored wire according to the invention, beyond the compositional flexibility, in particular on the oxygen content of the welds compared with a bulk wire of the prior art when SAW welding is used.

To do this, weld beads were produced on 9% Ni steel plates with a flux-cored wire according to the invention and, for comparison, with a bulk wire according to Example 1, under the same operating conditions, in particular with the same flux and the same welding energies.

The results obtained are given in Table 5 below.

TABLE 5

| | O (ppm) |
|---|---|
| Bulk wire of Example 1 | 310 |
| (prior art) | |
| Flux-cored wire of Example 3 | 250 |
| (invention) | |

These results are particularly surprising since, owing to the use of a flux-cored wire according to the invention, it might be expected to obtain an oxygen content in the deposited metal greater than that obtained with the bulk wire as the powder contained in the flux-cored wires is reputed to supply a large amount of oxygen into the weld.

However, the results obtained show that with a flux-cored wire according to the invention this is not the case, in particular owing to the absence of iron powder in the filling elements of the flux-cored wire of the invention.

It follows from this that the use of a flux-cored wire coupled with the use of a basic flux according to the invention makes it possible to have an oxygen content in the weld lower than that obtained with a bulk wire and a basic flux. This reduction in oxygen content is favourable for obtaining good toughness values.

The present invention therefore leads, as the results above show, to an effective welding process for assembling 9% Ni steel for cryogenic applications with a high productivity, while ensuring tensile properties of the level of that of the base metal and toughness and lateral expansion properties at very low temperatures superior to the minima required by the construction codes.

In other words, the welding process of the invention makes it possible to obtain a ductile microstructure and mechanical properties capable of meeting the requirements of cryogenic applications at −196° C., i.e. a minimum toughness of 34 J at −196° C. and a lateral expansion of at least 0.38 mm, with an economically satisfactory productivity.

1. Flux-cored wire for welding nickel steels, comprising a steel sheath and filling elements, characterized in that it contains, relative to the weight of the wire, 2 to 15% fluorine, 8 to 13% nickel, and iron.

2. Flux-cored wire according to claim 1, characterized in that the steel is a carbon-manganese steel, the carbon content of the sheath preferably being less than 0.05%.

3. Flux-cored wire according to claim 1, characterized in that the fill level of the wire with said filling elements is between 8 and 40%, preferably 12 to 30%, relative to the total weight of the wire.

4. Flux-cored wire according to claim 1, characterized in that the iron comes only from the steel sheath, the filling elements being free of iron, in particular free of iron powder.

5. Flux-cored wire according to claim 1, characterized in that it contains, relative to the weight of the wire, 8 to 15% fluorine and 9 to 11.75% nickel.

6. Process for arc welding, laser welding or hybrid laser/arc welding of at least one workpiece made of nickel steel, preferably at least one workpiece containing at least 6% nickel, in which a flux-cored wire according to claim 1 is employed.

7. Processing according to claim 6, characterized in that this is a submerged-arc welding process employing a flux-cored wire according to one of claims 1 to 5 and a flux containing, in proportions by weight, 25 to 35% MgO, 20 to 30% CaO, 10 to 15% SiO₂, 10 to 30% Al₂O₃ and 5 to 20% fluorine.

8. Process according to claim 6, characterized in that one or more workpieces made of steel containing more than 7% nickel, typically 7 to 13% nickel, are welded together.

9. Process according to claim 6, characterized in that a welded joint is produced such that the density of passes at the welded joint is greater than 2 passes per cm².

10. Welding flux that can be used in the process according to claim 7, characterized in that it contains, in proportions by weight, 25 to 35% MgO, 20 to 30% CaO, 10 to 15% SiO₂, 10 to 30% Al₂O₃ and 5 to 20% fluorine.

11. Flux according to claim 10, characterized in that it further includes at least one constituent chosen from Na₂O and K₂O, the proportion of said at least one constituent being less than 3% by weight.

12. Welded joint or deposited metal that can be obtained by melting a flux-cored wire according to claim 1, characterized in that it contains:
0.010 to 0.7% C, preferably 0.010 to 0.05% C;
0.02 to 0.20% Si;
0.15 to 0.6% Mn;
0.002 to 0.007% P;
0.0013 to 0.0050% S;
7 to 13% Ni;
0.002 to 0.012% Ti;
0.005 to 0.018% Al; and
predominantly Fe.

13. Welded joint or deposited metal according to claim 12, characterized in that it furthermore contains less than 300 ppm oxygen.

14. Flux-cored wire according to claim 2, characterized in that the fill level of the wire with said filling elements is between 8 and 40%, preferably 12 to 30%, relative to the total weight of the wire.

15. Flux-cored wire according to claim 2, characterized in that the iron comes only from the steel sheath, the filling elements being free of iron, in particular free of iron powder.

16. Flux-cored wire according to claim 2, characterized in that it contains, relative to the weight of the wire, 8 to 15% fluorine and 9 to 11.75% nickel.
